(19) United States
(12) Patent Application Publication
(10) Pub. No.: US 2015/0261929 A1
(43) Pub. Date: Sep. 17, 2015

(54) SYSTEM AND METHOD FOR DETERMINING THE EFFECTIVENESS OF ELECTRONIC THERAPEUTIC SYSTEMS

(71) Applicant: Edify Incorporated, Eagle, ID (US)

(72) Inventor: Keith P. McGuinness, Eagle, ID (US)

(21) Appl. No.: 14/658,844

(22) Filed: Mar. 16, 2015

Related U.S. Application Data
(60) Provisional application No. 61/954,282, filed on Mar. 17, 2014.

(51) Int. Cl. G06F 19/00; G09B 5/02

(52) U.S. Cl. CPC G06F 19/3406; G06F 19/3481; G09B 5/02

(57) ABSTRACT

Embodiments of this invention relate to electronic therapeutic systems. More specifically, this invention relates to computer systems and computer-implemented methods for monitoring a therapeutic attribute, and for determining the effectiveness of electronic therapeutic systems, namely, software applications and associated components designed to provide a therapeutic result, in providing changes to the therapeutic attribute to reach a user's desired therapeutic objective.

### CROSS REFERENCE TO RELATED APPLICATION

This application claims the benefit of priority to U.S. Provisional Patent Application Ser. No. 61/954,282, filed Mar. 17, 2014, entitled COMPARATIVE EFFECTIVENESS OF THERAPEUTIC SYSTEMS, the disclosure of which is expressly incorporated herein by reference.

### FIELD OF THE INVENTION

Embodiments of this invention relate to electronic therapeutic systems. More specifically, embodiments of this invention relate to computer systems and computer-implemented methods for monitoring a therapeutic attribute, and determining the effectiveness of electronic therapeutic systems, namely, software applications and associated components designed to provide a therapeutic result, in providing changes to the therapeutic attribute to reach a therapeutic objective.

### BACKGROUND OF THE INVENTION

In recent years digital technology has evolved to the point where software applications, commonly referred to as “apps,” are relatively easy to build and distribute. During the past 5 years, tens of thousands of apps have entered the market offering to assist with the health or wellness objectives of consumers. Many of these offer assistance with the behavior modification objectives of individuals suffering from obesity, diabetes, hypertension, anxiety, medication non-adherence and other circumstances, conditions or diseases which have a behavioral component. The marketing materials for these software apps typically imply a therapeutic result but lack reliable evidence of a measurable health outcome, or evidence that a measurable outcome was brought about specifically by the user's interaction with that app. In some cases, these products may be developed for a purpose unrelated to therapy, such as using the promise of a desired health outcome to build a large volume of user traffic for the mere purpose of attracting revenue from advertisers. Such an objective may be in conflict with the objective of achieving legitimate and measurable therapeutic results, as measurable therapeutic results may be unnecessary to build traffic and attract advertisers in certain instances.

Whether a therapy is delivered in the form of a drug or as a software application, the objective of that therapy is to be effective. Typically, a drug will have a specific mechanism of action that advances a targeted therapeutic objective and produces certain measurable therapeutic results. In this respect drug therapy and software, when intended as therapy, should be alike. In each therapeutic system, whether drug or software, one or more mechanisms must bring about a measurable therapeutic result consistent with a therapeutic objective.

While the pharmaceutical industry is mature and the processes needed to ensure the effectiveness of a drug therapy are well known, the concept of software as an electronic therapeutic agent is new. The mobile phone and the rise of the app as a popular digital product have given rise to thousands of so-called health and wellness apps that claim to help improve one's health. Anecdotally, it seems that many of these apps may indeed have therapeutic value. Nonetheless there have been relatively few objective attempts to measure the value of such apps. Software technology moves too rapidly for traditional research methods to produce relevant, timely results. By the time research findings are published, newer and typically improved versions of the apps and the mobile phones (or other devices running the apps) may already be available. Consequently, the traditional testing methods used to establish the efficacy of a drug before it is marketed to consumers are insufficient for software products that change continuously throughout their product lifecycle.

### SUMMARY OF THE INVENTION

Fundamental to an understanding of software as a truly beneficial therapy is the recognition that, unlike the static chemistry of a drug, the code, content and technology necessary to the function of a software application are dynamic and adaptive. Software evolves, as does the technology that enables a consumer to interact with it, e.g., a device and an operating system. For this reason a software application, used as a therapeutic agent, may be determined to be effective only within the context of an “electronic therapeutic system,” which may comprise additional components and factors that affect the software's contribution to a particular therapeutic objective. Accordingly, the therapeutic effectiveness of a software application must be monitored at intervals of adequate frequency throughout the life of the application to ensure that changes to the electronic therapeutic system, of which it is a component, do not diminish therapeutic effectiveness over time.

Furthermore, the advances in mobile and data technology that have allowed software to be utilized as a therapeutic agent as described herein, also advance the utility of software applications to improve the effectiveness of other therapies. The ability to measure the therapeutic effectiveness of a software application implies the ability to evaluate the effectiveness of other therapeutic processes if sufficient, relevant data about the other therapies flows through software. For instance, one or more therapeutic systems may comprise a software application that targets weight control in an effort to improve blood glucose control. Such application may also collect information about the patient's medication adherence. The analysis of data from such a therapeutic system could indicate whether compliance with the software improves compliance with the medication, or the reverse. The data may also provide insights about the relative effectiveness of alternative therapy combinations for certain populations.

Various embodiments of the present invention pertain to systems and methods to monitor the therapeutic effectiveness of electronic therapeutic systems, enable comparison of effectiveness among electronic therapeutic systems and components thereof, and advance the potential of software to contribute to desirable health outcomes.

One aspect of the present invention pertains to a computing system comprising a processor and a memory including programming that, when executed by the processor, causes the computing system to periodically receive data generated by a plurality of electronic therapeutic systems, wherein the data include the status of at least one therapeutic attribute, and wherein each of the plurality of electronic therapeutic systems includes a therapeutic objective, monitor changes in the at least one therapeutic attribute over time, and compare the effectiveness of two or more electronic therapeutic systems sharing the same therapeutic objective at creating a desired change in the at least one therapeutic attribute over time. In some embodiments, each electronic therapeutic system includes a device component, an operating system component hosted on the device component, and a software application component accessible by the device component, and wherein the device component is communicatively coupled to the computing system. In further embodiments, the device component is a general purpose computer, smart phone, tablet computer, wearable biometric tracking device or wearable computing device. In certain embodiments, the data generated by the plurality of electronic therapeutic systems include identification of the device component, the operating system component and the software application component. In some embodiments, the memory includes programming that, when executed by the processor, causes the computing system to identify correlations between changes in the at least one therapeutic attribute and changes in at least one of the device component, the operating system component and the software application component. In further embodiments, the data generated by the plurality of electronic therapeutic systems include personal characteristics of users of the plurality of electronic therapeutic systems. In certain embodiments, the memory includes programming that, when executed by the processor, causes the computing system to identify correlations between changes in the at least one therapeutic attribute and differences between the personal characteristics of the individuals. In some embodiments, changes in the at least one therapeutic attribute that exceed a predetermined threshold are reported to a healthcare constituent, developer, or third-party service. In further embodiments, the computing system further comprises at least one data repository for storing the received data.

Another aspect of the present invention pertains to a computer-implemented method comprising receiving data generated by a plurality of electronic therapeutic systems, wherein the data include the status of at least one therapeutic attribute, monitoring changes in the at least one therapeutic attribute over time, and comparing the effectiveness of two or more electronic therapeutic systems at creating a desired change in the at least one therapeutic attribute over time, wherein the data is received by a computing system communicatively coupled to the plurality of electronic therapeutic systems. In some embodiments, each electronic therapeutic system includes a device component, an operating system component hosted on the device component, and a software application component accessible by the device component. In further embodiments, the device component is a general purpose computer, smart phone, tablet computer, wearable biometric tracking device or wearable computing device. In certain embodiments, the data generated by the plurality of electronic therapeutic systems include identification of the device component, the operating system component and the software application component. In some embodiments, the computer-implemented method further comprises identifying correlations between changes in the at least one therapeutic attribute and changes in at least one of the device component, the operating system component and the software application component. In further embodiments, the data generated by the plurality of electronic therapeutic systems include personal characteristics of users of the plurality of electronic therapeutic systems. In certain embodiments, the computer-implemented method further comprises identifying correlations between changes in the at least one therapeutic attribute and differences between personal characteristics of users of the plurality of electronic therapeutic systems. In some embodiments, reporting changes in the at least one therapeutic attribute that exceed the predetermined threshold comprises generating an output report to a healthcare constituent, developer, or third-party service reflecting changes in the at least one therapeutic attribute that exceed the predetermined threshold. In further embodiments, the receiving data generated by a plurality of electronic therapeutic systems is received periodically. In certain embodiments, the receiving data generated by a plurality of electronic therapeutic systems is received continuously.

A further aspect of the present invention pertains to a non-transitory computer-readable medium comprising stored contents that configure a computing system to periodically receive data generated by a plurality of electronic therapeutic systems, each electronic therapeutic system including a therapeutic objective, a device component, an operating system component hosted on the device component, and a software application component accessible by the device component, and wherein the data include the status of at least one therapeutic attribute, personal characteristics of users of the plurality of electronic therapeutic systems, and identification of the device component, the operating system component and the software application component, monitor changes in the at least one therapeutic attribute over time, identify correlations between changes in the at least one therapeutic attribute and differences in the device component, operating system component, software application component, or personal characteristics of users of the plurality of electronic therapeutic systems, and compare the effectiveness of two or more electronic therapeutic systems sharing the same therapeutic objective at creating a desired change in the at least one therapeutic attribute over time.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

A better understanding of the present invention will be had upon reference to the following description in conjunction with the accompanying drawings.

FIG. 1 is a diagram depicting an exemplary therapeutic system in accordance with embodiments of the present invention.

FIG. 2 is a diagram depicting an exemplary therapeutic effectiveness service in accordance with embodiments of the present invention.

FIG. 3 is a flow chart depicting a method of providing a therapeutic effectiveness determination in accordance with embodiments of the present invention.

FIG. 4 is an exemplary report, to a software developer, of findings of an exemplary therapeutic effectiveness service in accordance with embodiments of the present invention.

FIG. 5 is an exemplary report, to a software developer, of findings of an exemplary therapeutic effectiveness service in accordance with embodiments of the present invention.

FIG. 6 is an exemplary report, to a healthcare provider, of findings of an exemplary therapeutic effectiveness service in accordance with embodiments of the present invention.

FIG. 7 is an exemplary report, to a healthcare provider, of findings of an exemplary therapeutic effectiveness service in accordance with embodiments of the present invention.

### DETAILED DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims.

Provided herein are systems and methods associated with evaluating and documenting the effectiveness of electronic therapeutic systems. More specifically, the monitoring, analysis and mining of data collected at intervals of various frequencies from electronic therapeutic systems can be used to measure and indicate the effectiveness of such systems in terms of a therapeutic objective on an ongoing, real-time basis. These methods and systems provided by this invention enable comparisons between electronic therapeutic systems in terms of therapeutic objectives and, further, afford a basis for matching specific therapeutic systems to specific individuals. Still further, applying such mining techniques to the data can empower the developers of electronic therapeutic system components to accelerate system improvements and repairs.

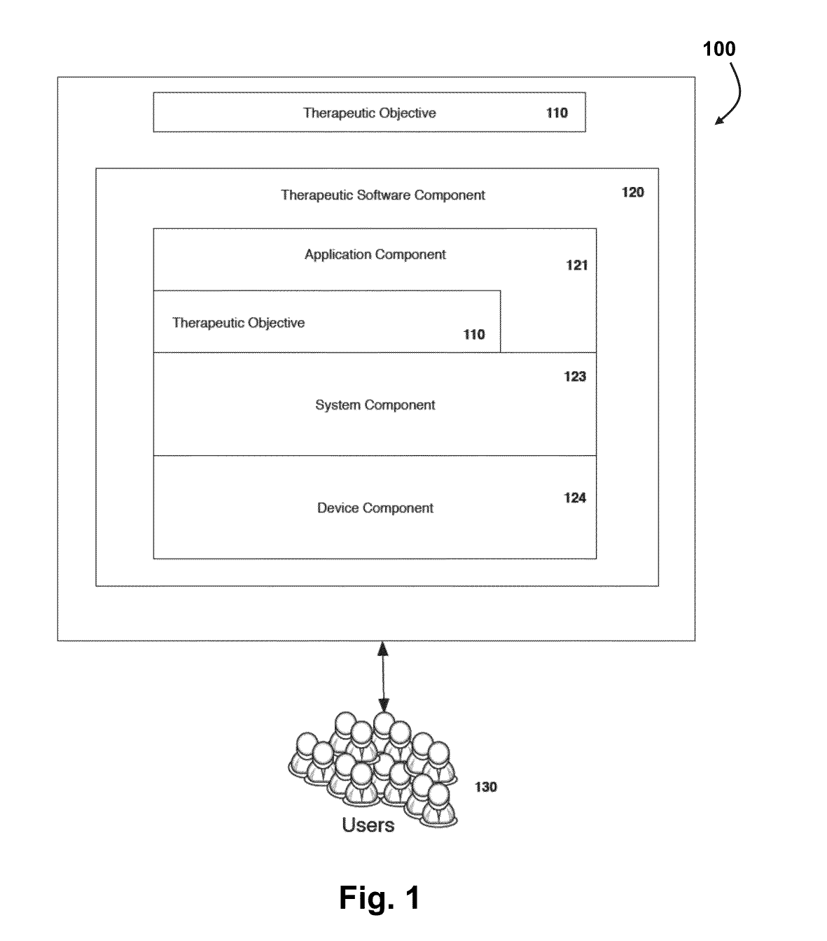

Referring now to FIG. 1, an exemplary electronic therapeutic system 100 is depicted in accordance with one aspect of this invention. Therapeutic system 100 has a therapeutic objective 110, and at least one user 130 shares the therapeutic objective 110 of the system 100. The at least one user 130 is preferably an individual who uses the electronic therapeutic system 100 to achieve the desired therapeutic objective 110 of the system. A therapeutic objective may be, for example, to lower body weight, reduce blood glucose levels, manage blood pressure, improve adherence to a medication regimen, or other health-improving goal(s) or a combination(s) thereof. The electronic therapeutic system 100 comprises a collection of components (as discussed below) that come together in a myriad of combinations to achieve, or affect the achievement, of a therapeutic objective 110 to the benefit of at least one user 130.

Electronic therapeutic system 100 comprises at least one therapeutic software component 120. Software component 120 comprises, in turn at least one software application component 121, having at least one therapeutic objective 110; at least one operating system component 123; and at least one device component 124. Common operating system components available on the market today include, but are not limited to, Apple (iOS), Android or Windows operating systems used to operate smart phones and tablet computers, and various Windows, Apple, UNIX, Linux-based operating systems used to operate desktop and laptop computers, and dedicated software used to operate biometric tracking devices. The operating system component 123 enables the application component 121 to operate or interact with the device component 124. Device component 124 may be any device or plurality of devices used to interact with an application component 121 or to exchange information with other components or therapeutic systems. Exemplary device components 124 include, but are not limited to, general purpose computers, smart phones, tablet computers, wearable biometric tracking devices (such as blood pressure monitors, heart monitors, stress monitors, sleep monitors, brain wave monitors and similar devices), or wearable computing devices such as watch-like body-borne computers.

The application component 121 may be installed on the device 124 or accessed via the Internet or other means for electronic communication. Common application components include, but are not limited to, apps designed to help one lose weight, track blood pressure, track blood glucose levels, track physical activity, monitor stress and anxiety, maintain a food diary, find social support for behavioral changes such as changing eating habits, and improve adherence to a medication regime. Electronic therapeutic system 100 may, in some embodiments, further or alternatively include non-electronic components, such as ingesting medications, exercise routines, and other therapeutic activities that are managed, monitored or tracked by the user using the software application component 121.

A therapeutic objective 110 of this invention may, for example, be to improve blood glucose control for individuals with Type 2 diabetes as noted above. Electronic therapeutic system 100 may comprise a plurality of components that are combined to address elements of treatment appropriate to improved blood glucose control. Such elements of treatment may comprise, for example, a behavior change element targeting weight management, and a medication adherence element targeting insulin resistance. System 100 may have a more simple therapeutic objective 110 to, for example, improve blood pressure for users, or a complex or combination therapeutic objective 110 to, for example, improve blood pressure for female users over the age of 65 with Type 2 diabetes.

In some embodiments, an electronic therapeutic system 100 may be created by intentional design. In one example, a commercial enterprise may develop a number of proprietary components, including medical devices and software application components, and offer them as a single integrated commercial product. In another example, a physician may prescribe a medication to a patient to address insulin resistance while also recommending that the patient employ a software application (i.e. the application component 121 in FIG. 1) to improve the patient's eating habits that is compatible with the patient's smart phone (the device component 124, where the patient's phone's operating system would serve as the operating system component 123).

In other embodiments, the electronic therapeutic system 100 may be assembled in a piecemeal fashion. For example, a consumer using a prescribed medication to address insulin resistance may decide to download onto the consumer's smart phone a weight loss app recommended by a friend, and download onto the consumer's desktop computer a medication adherence app discovered while browsing a social network, and thereafter experience improvement in blood glucose control by using the apps in combination with each other. In this example, the consumer has built a “personalized” electronic therapeutic system 100.

Therapeutic system 100 may also comprise a plurality of device components 124, a plurality of operating system components 123, and a plurality of application components 121. In one embodiment, a relatively simple electronic therapeutic system 100 may comprise two devices 124, such as a mobile phone and an accelerometer. The mobile phone 124, together with its operating system 123, may be used to interact with other devices that address one or more treatment elements of blood glucose control. An accelerometer, for example, may also serve as a device component 124 of system 100, employed to advance the therapeutic objective 110 (again, to improve blood glucose control) by advancing treatment elements that address, for instance, increased metabolism or weight loss or weight maintenance. It is also possible that a single device or application may address a plurality of treatment elements, such as both weight management and medication adherence for example.

As noted above, therapeutic system 100 may in certain embodiments comprise a plurality of device components 124, a plurality of operating system components 123, and a plurality of application components 121. As a further example, a simple therapeutic system 100 may comprise a simple smartphone (the device component 124), an operating system for the smartphone (the operating system component 123), and a single software application (the application component 121) to assist the user in weight loss (whereas weight loss is the therapeutic objective 110). A more complex therapeutic system 100 may, on the other hand, include several device components 124, including a smartphone, a tablet computer, a glucometer, and an accelerometer; several operating system components 123 to manage the multiple device components 124; and several applications components 121 to assist with behavior change associated with several therapeutic objectives 110, which may include, for instance, maintaining proper blood sugar levels for Type 2 diabetes, maintaining healthy blood pressure levels, and medication adherence. It should be appreciated that the volume and frequency of changes in electronic therapeutic system 100 will vary over time, that more complex electronic therapeutic systems 100 will tend to produce a greater volume of change at a greater frequency than simple electronic therapeutic systems, and that different electronic therapeutic systems will require different patterns and frequencies of data gathering and monitoring.

An application component 121 may also become a component of a therapeutic system 100 through trial and error. For example, a user 130 of therapeutic system 100 may try a variety of device components 124 and application components 121 over time, each combination of components forming a distinct electronic therapeutic system 100 and yielding a distinct therapeutic result. The potential for an almost unlimited number of distinct electronic therapeutic systems 100 should be appreciated. Further, a combination of therapeutic systems 100 having different, but complimentary therapeutic objectives 110, may be linked to target the complex needs of an individual user 130.

The discussion of therapeutic effectiveness is more commonly associated with drug medications. Unlike the design of a drug that, once approved, does not change, the design of software used as a therapy is likely to change continuously, as may the components of any electronic therapeutic system 100 necessary for a user 130 to operate a software application component 121 and achieve a desired therapeutic result. A randomized controlled trial conducted to evaluate the effectiveness of software is only useful if the marketed product continually and identically mirrors the trial design. Change to any component of therapeutic system 100 decreases its fidelity to a trial experiment. Therefore, an electronic therapeutic system 100 that includes a software application component 121 must receive data and measure the effectiveness of the system 100 relative to a therapeutic objective 110, periodically, and in some embodiments, continuously. An electronic therapeutic system 100 may find that individual or cumulative changes to software components significantly affect the therapeutic results of the system over time. For commercial therapeutic products incorporating software and approved by the FDA or other regulatory body, there is a risk that the product may, over time, drift away from the specifications approved originally by the regulatory body.

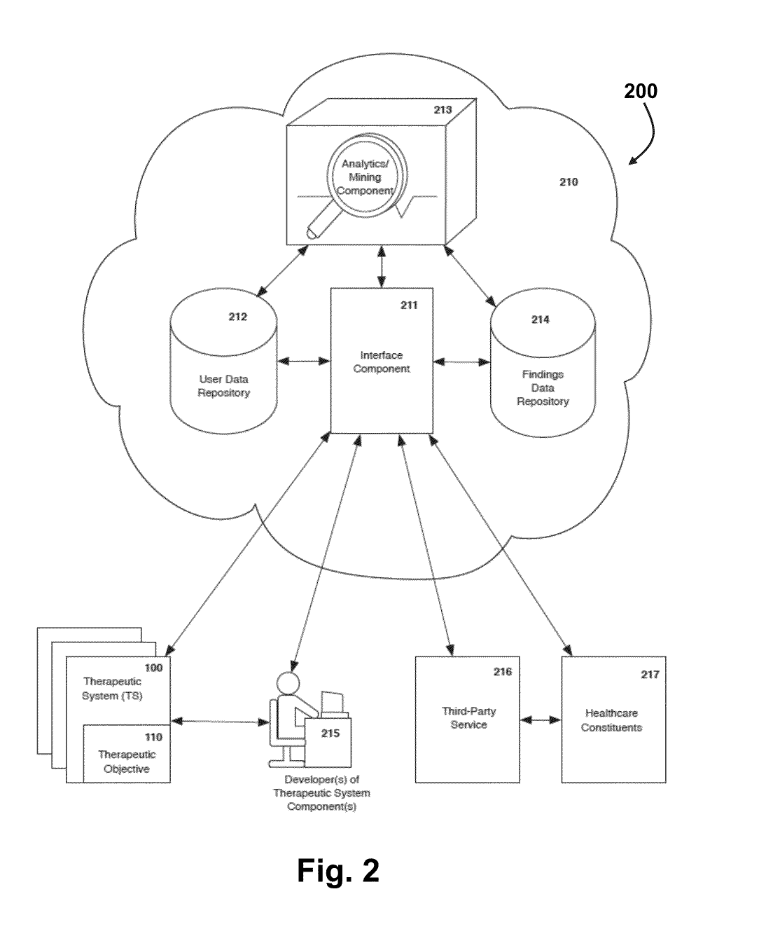

Referring now to FIG. 2, a computer-implemented comparative effectiveness system 200 and a computing system 210 are depicted in accordance with an aspect of this invention. The computing system 210 utilized in conjunction with embodiments described herein will typically include a processor in communication with a memory, and a network interface. (Power, ground, clock, and other signals and circuitry are not discussed, but will be generally understood and easily implemented by those ordinarily skilled in the art.) The processor, in some embodiments, is at least one microcontroller or general purpose microprocessor that reads its program from memory. The memory, in some embodiments, includes one or more types such as solid-state memory, magnetic memory, optical memory, or other computer-readable, non-transient storage media. In certain embodiments, the memory includes instructions that, when executed by the processor, cause the computing system 210 to perform a certain action. Computing system 210 also preferably includes a network interface 211 connecting the computing system 210 to a data network for electronic communication of data between the computing system 210 and other devices attached to the network. In certain embodiments, the processor includes one or more processors and the memory includes one or more memories. In some embodiments, computing system 210 is defined by one or more physical computing devices as described above. In other embodiments, as depicted by the cloud design in FIG. 2, the computing system 210 may be defined by a virtual system hosted on one or more physical computing devices as described above.

The computing system 210, which can be accessible to constituents over a wide area network (WAN) such as the Internet or other data network, provides functionality to surveil data about, among other things, the therapeutic attributes of a therapeutic objective 110 at intervals and frequencies that reflect the dynamic nature of a particular therapeutic system 100. As used herein, the term therapeutic attribute comprises any quality or feature regarded as a characteristic of or relevant to a therapeutic objective. A therapeutic attribute may comprise, for example, outcomes or other measures related to a health condition or disease or the treatment of a health condition or disease, the personal characteristics of a person or population of persons, the timing and nature of a change affecting the performance of a component of a therapeutic system, or any other feature or characteristic that may affect a therapeutic objective of an individual or group of individuals utilizing an electronic therapeutic system.

Accordingly, the computing system 210 shown in FIG. 2 includes interface component 211 communicatively coupled to an analytics/mining component 213, or simply an analytics component, and data repositories 212, 214. Interface 211 may be operable to facilitate communication with the data repositories 212, 214 and between one or more electronic therapeutic systems 100 and the computing system 210. The interface component 211 may also be operable to facilitate communication between the computing system 210 and developers of therapeutic system components 215, third-party services 216, or healthcare constituents 217. Accordingly, interface component 211 may be configured to manage access to available data in accordance with the law, regulation, user permission, business needs, social norms, confidentiality or other factor.

The interface component 211 can be embodied as software that configures the computing system 210 to obtain or otherwise receive data from a component of an electronic therapeutic system 100 and deliver said data to the user data repository 212. It should also be appreciated that therapeutic system 100 data may be received or otherwise collected by the computing system 210 in a variety of manners. Interface component 211 may, for example, be configured to pull or otherwise receive data directly from an electronic therapeutic system 100, application component 121 or device component 124 or, in another instance, a developer 215 may permit the interface component 211 to be communicatively coupled to a cloud-based data repository owned or controlled by the developer 215 and which sits between one or more therapeutic systems 100 and the computing system 210.

The analytics component 213 depicted in FIG. 2 can be embodied as software that configures the computing system 210 to surveil data housed in the user data repository 212; to measure therapeutic attributes; to draw inferences about the effect of interactions between the user 130 and the various components of a therapeutic system 100 on a therapeutic objective 110; and/or to identify possible causes of unexpected fluctuations in the measure of a therapeutic attribute that may be useful to developer 215 to improve therapeutic system 100. The analytics component 213 can use a single or combination of analysis and mining techniques including, without limitation, statistics, regression, descriptive, exploratory, inferential, predictive, causal, mechanistic, semantic and the like, in order to monitor the effectiveness of therapeutic systems 100 and measure, compare, draw inferences, identify correlations, provide insights, and more, amongst the data housed in the data repositories 212, 214.

The analytics component 213 may also be configured as a check on the data received by the interface component 211 before said data is transferred to the user data repository 212 or processed by the analytics component 213. For example, an algorithm employed by analytics component 213 may be trained to expect certain types of data when an electronic therapeutic system 100 presents with certain characteristics and, when such expected data is not present or unexpected data is encountered, report an exception. For example, a new or missing version identifier for a therapeutic system component 120 may be reported, or a sudden, unexpected change in the trajectory of a monitored therapeutic objective 110 may be reported, or new data about the characteristics of users 130 may be reported when introduced.

In FIG. 2, data repositories are depicted as a user data repository 212 and a findings data repository 214. In some embodiments, the application user data repository 212 serves to store the data received from the interface component 211 and make it available, as appropriate, to the analytics component 213. The findings data repository 214 serves to store the data received from the analytics component 213 and make it available, as appropriate, to the interface component 211 that, in turn, may interact with developers of therapeutic system components 215, third-party services 216, or healthcare constituents 217, such as healthcare providers or healthcare insurance providers. It should be appreciated that the interface component 211 may be configured to receive information from healthcare constituents 217 for comparison to or analysis with information stored in either data repository 212, 214. In some embodiments, the data repositories 212, 214 may be embodied in a single, pair, or plurality of databases or other non-transitory computer readable storage media.

There are various exemplary scenarios in which the subject comparative effectiveness system 200 can be utilized. The following six scenarios are offered by way of example and not to limit the scope of this invention.

1. The computing system 210 can surveil therapeutic system 100 data from application components 121 that promise to improve, for instance, the results of users' A1c blood sugar level tests. It can calculate the change in A1c at intervals, for example, between the first recorded A1c of a user 130 and the second recorded A1c, then periodically thereafter. It can compare the results so computed between a plurality of application components 121 that share controlling A1c blood sugar level as a therapeutic objective 110, rank the applications according to the change in A1c, and report the ranking In some embodiments, the ranking may be reported in compendium, similar to those used in the pharmaceutical industry.

2. The computing system 210 can measure the impact on users 130 of the addition, replacement or upgrade of a component to a therapeutic system 100. In effect, the addition, replacement or upgrade of a component in a therapeutic system 100 creates a new therapeutic system 100 for the user 130. It should be of interest to the user 130 as well as the user's healthcare provider and others whether the former or latter therapeutic system is more effective for a user 130.

3. Extending the immediately prior scenario, the computing system 210 can compare the therapeutic effectiveness of any number of distinct therapeutic systems 100 to learn whether one is more effective than another, or whether one is more effective than another for, for example, a particular population group of users 130. The computing system 210 can rank a plurality of therapeutic systems 100 according to their therapeutic effectiveness relative to a therapeutic objective 110 or attribute. As data accumulates from a plurality of electronic therapeutic systems 100, the computing system 210 may infer from the data whether, for example, a particular therapeutic system that seeks improvement in the management of Type 2 diabetes is more effective for Latino Americans than for other population groups. This will enable the healthcare constituents 217 to better match a specific electronic therapeutic system 100 to a specific user 130.

4. Each developer 215 may have different knowledge about therapeutic objectives 110. Accordingly, each developer may decide independently which data will be collected by the component under his or her development. The computing system 210 can be used to infer from data collected from a plurality of therapeutic systems 100 whether, for example, the very presence of certain data correlate to better therapeutic results for a particular therapeutic objective 110. Such knowledge may draw those developers 215 not yet collecting said data to a greater understanding of a particular therapeutic objective 110 and motivate design changes in the system or components that would have been delayed without this new knowledge.

5. The degree of effectiveness of a therapy depends in part on the beneficial matching of a therapy to the personal characteristics of a consumer or patient. Such personal characteristics include, but are not limited to, age, gender, weight, race, ethnicity, socio-economic level, medications taken, existing disease states, employment status, marital status, stress level, location of residence, and significant life events such as marriage, divorce, pregnancy, and others. A healthcare constituent 217, a physician in this example, may access the computing system 210 to learn whether the comparative effectiveness system 200 may identify therapeutic systems 100 or components thereof that may be a beneficial match to the therapeutic objectives 110 and personal characteristics of a certain patient or patient population. In this instance a physician 217 would submit information about the personal characteristics of such patient or patient population for comparison to or analysis with information contained in the data repositories 212, 214. As the number of therapeutic systems 100 that use the comparative effectiveness system 200 grows, the number of possible beneficial matches of therapeutic systems 100, or components thereof, to particular persons or populations is expected to grow as well.

6. The use of software as a therapeutic component is a relatively new practice. To provide evidence of effectiveness, some developers 215 have undertaken a traditional research approach, such as an historical observational study or a randomized controlled trial (RCT). However, the application of traditional research methods to therapeutic systems comprising a software application component 121 confronts the requirement of experiment fidelity. The comparative effectiveness system 200 obviates the need for experiment fidelity by directly and frequently measuring the impact of changes throughout the life of the electronic therapeutic system 100. The information so generated can be leveraged to extend the value of the basic science produced by an RCT, for instance, by accelerating the validation of subsequent changes to the therapeutic system through direct measurement. The effect of this validation approach may be to help developers 215 maintain or increase the therapeutic effectiveness of products, while reducing the cost associated with updating experiments using conventional research methods.

As noted, in FIG. 2 constituents of the computing system 210 include developers of therapeutic system components 215 or simply “developers”; third-party services 216; and healthcare constituents 217. Developer 215 may affect the design and operation of a component of therapeutic system 100. Developer 215 may also communicate with the computing system 210 through interface component 211 to exchange information that may empower the developer to improve a component of therapeutic system 100 relative to a therapeutic objective 110. For example, analytics component 213 may identify a sudden, statistically significant increase in high or low blood glucose readings at a particular time of day for a particular therapeutic system 100. Analytics component 213 may also provide information about possible or likely causes for the change in the therapeutic attribute (i.e., the glucose readings). For example, it may be found that the increase in undesirable glucose readings correlates highly with the date of an update to a particular component of the electronic therapeutic system 100. This information may inform the developer 215 of that component that the update contains an error and requires prompt repair. Developer 215 may then use such information to investigate the cause of the increase and, finding it related to the design of a component, take corrective action to improve the design of the component. Such information may accelerate the improvement of therapeutic systems 100 and afford a competitive advantage to developers 215 motivated to compete based on comparative therapeutic effectiveness of their software products.

Third-party services 216 are entities that can provide or have a need to receive information regarding the health of users 130 of electronic therapeutic systems 100. Third-party services 216 comprise entities managing, operating and providing data for electronic medical record (EMR) systems, electronic health record (EHR) systems, personal health record (PHR) systems, health information exchanges, and similar health information repositories. Healthcare constituents 217 can comprise health consumers (such as patients); healthcare providers (which include, but are not limited to, physicians, nurse practitioners, physician assistants, health coaches, pharmacists, psychologists, hospitals, clinics and physician practices); and other entities in the healthcare industry (including, but not limited to, health insurance providers, pharmaceutical companies, health information exchanges; and any other system, service, individual, group, or entity with a personal or economic interest in health outcomes).

Third-party services 216 and healthcare constituents 217 may interact with the interface component 211 to access the computing system 210. For example, a physician 217 may request an EHR provider 216 to access the computing system 210 on the physician's behalf to obtain individual patient information or data, and deliver such data to the physician's practice through an EHR dashboard. As another example, a pharmaceutical company may access the computing system 210 through the interface component 211 to obtain information about the effect of a particular electronic therapeutic system 100 or combination of systems 100 on the medication adherence of a particular drug. In yet another example, a third-party service 216 that offers a drug reference application to healthcare constituents 217, such as healthcare providers with prescription authority, may access the computing system 210 through the interface component 211 to acquire the information needed to operate a therapeutic system reference service. In still yet another example, healthcare constituents 217, such as members of the general public with healthcare needs, may access the service through the interface component 211 or through a third-party service 216 to obtain a list of electronic therapeutic systems 100 listed by therapeutic objective 110 and ranked according to comparative therapeutic effectiveness.

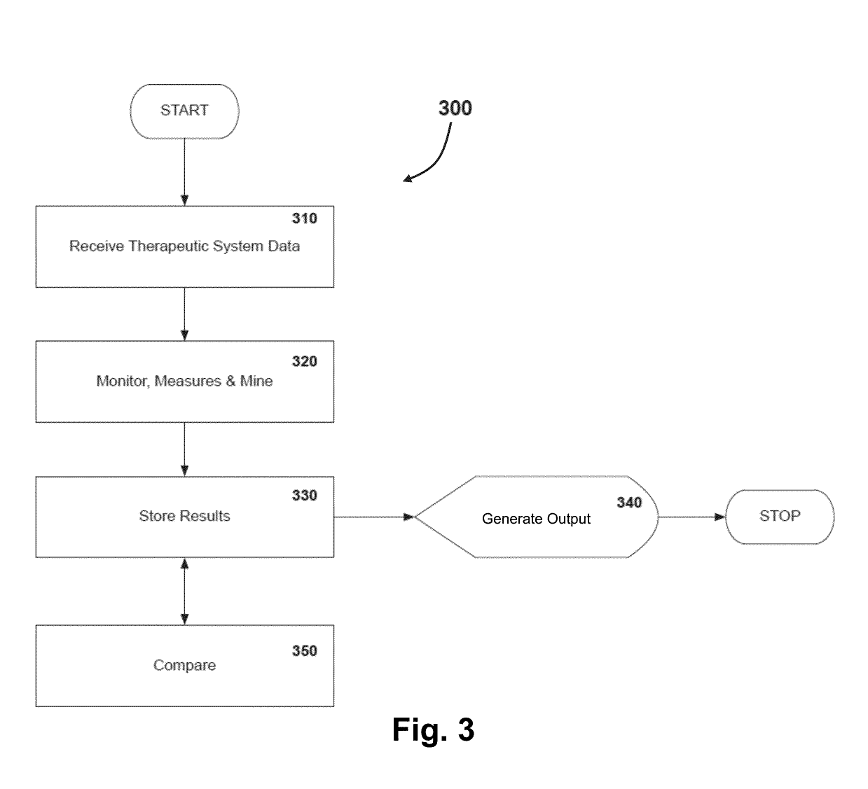

Referring now to FIG. 3, a flow chart diagram of a method of comparing the effectiveness of electronic therapeutic systems is presented in accordance with an aspect of this invention. Method 300 provides actions and generates outputs associated with a determination of the effectiveness of one or more electronic therapeutic systems 100 from data associated with the use of that (those) therapeutic system(s) 100, and the subsequent comparison of effectiveness among a plurality of electronic therapeutic systems 100, for instance. In practice, therapeutic system 100 data can be initially received or otherwise obtained by computing system 210 at 310. Such data may include data generated by electronic therapeutic systems 100 and other data associated with users 130 of the electronic therapeutic systems 100, such as medical data received from third-party services 216. For example, available data may indicate how many times users 130 interacted with particular features of an application component 121; the value of therapeutic metrics such as A1c blood sugar levels or user weight; the various devices 124 used by users 130 of electronic therapeutic systems 100; and the dates, times or nature of version changes to therapeutic system components.

All or a subset of the received or otherwise collected data can then be analyzed or mined at 320 to, among other things, identify changes in a metric corresponding to a therapeutic objective 110 of any therapeutic system 100; suggest possible causes of the identified changes; identify groups of users 130 that receive disproportionately good or bad therapeutic results, and much more. These findings may then be stored at 330 for later access and provided to the developer or other constituents of the service by generating an output at 340.

Where the data received or otherwise collected at 310, analyzed at 320, and stored at 330, correspond to more than one therapeutic system 100, comparison of findings relative to the several therapeutic systems can be conducted at 350. Depending upon the richness of the data received or otherwise collected at 310, the comparative analysis conducted at 350 may afford significant benefit. For example, the comparative analysis may find that one therapeutic system is particularly effective for a particular population, for example, Hispanic women aged 35-55; or overweight men with stage 1 hypertension and pre-diabetes. In another example, the comparative analysis at 350 may include data mining that identifies particularly effective combinations of therapeutic components or systems 100. For example, the combination of a therapeutic system targeting weight control with another therapeutic system targeting medication adherence may be found to be particularly useful to African-American men in their 60s.

The findings that result from the comparing step 350 may then be stored at 330 (as shown by the bi-directional reference arrow connecting 330 and 350) and made available via generated output reports (as discussed below) at 340 to constituents of the service through a variety of means.

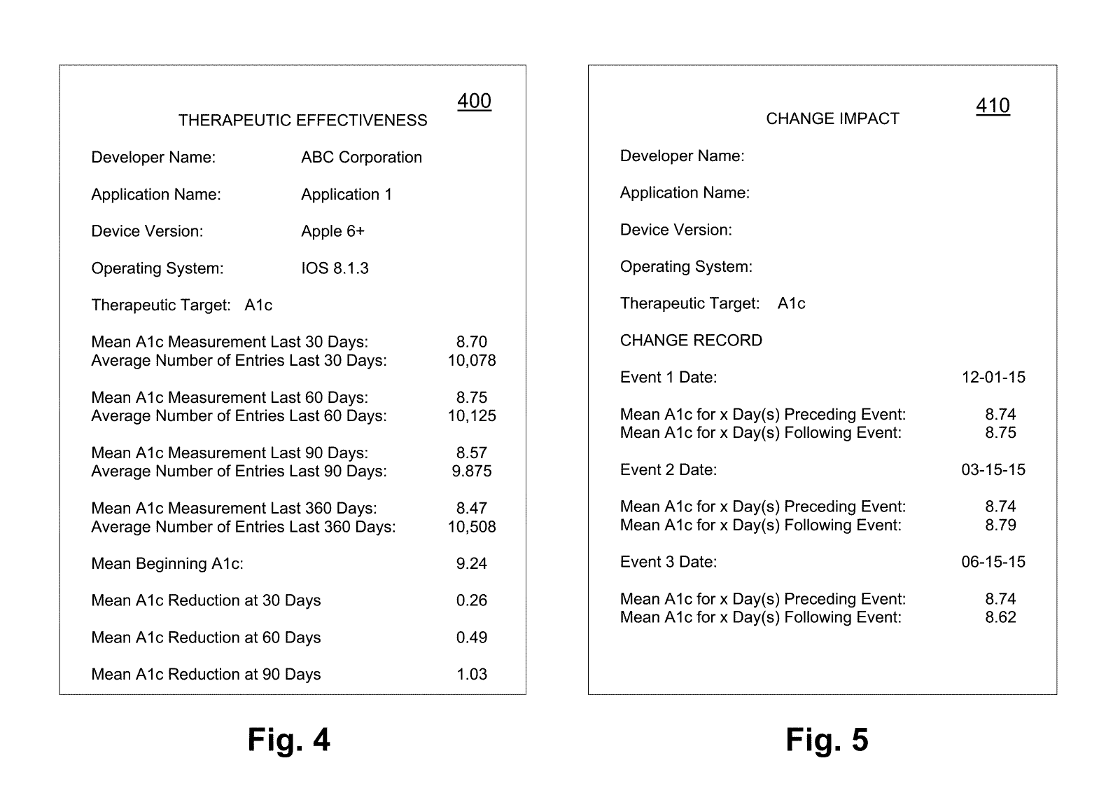

FIG. 4 is an exemplary Therapeutic Effectiveness output report 400 presenting a sample of the output information generated by the system 100 that may be made available to a developer 215 of a system 100 component as a constituent of the computing system 210. In the example depicted in FIG. 4, the developer 215 of an application component 121 is provided with information indicating the effectiveness of the therapeutic software 120 of therapeutic system 100 relative to a therapeutic objective 110 at various intervals over time. The information includes a description of the application component 121, the operating system component 123, and the device component 124 used to operate the application component 121. In the illustrated example, the therapeutic objective 110 is the “A1c” measurement. A1c is a measure of a person's average levels of blood glucose, also called “blood sugar,” over the past three (3) months. A1c is presented as the mean for a population of users for a period of “x” days where, in FIG. 4, “x” is 30, 60, and 90 days. The average number of user-entered A1c readings during the corresponding period is also presented for each interval. Also shown in the example is the mean beginning A1c for all users 130 of the electronic therapeutic system 100 and the mean A1c reduction for users 130 at various points in time after their initial A1c reading was recorded. In FIG. 4, A1c readings measured subsequent to the date of the beginning A1c reading showed a decrease of 0.26 at 30 days from the beginning reading, a decrease of 0.49 at 60 days from the beginning reading, and of 1.03 at 90 days from the beginning reading, wherein all reductions are measured as compared to the beginning A1c reading. Any number of data points may be presented and the data may be presented in any number of ways, including graphical or other methods. Upon review of these data a developer 215 may be motivated to investigate unexpected results or undesirable trends and to take action to improve the therapeutic system 100 relative to the therapeutic objective 110.

A developer 215 may receive a Therapeutic Effectiveness output report 400 generated by system 100 for any application component 121 or for any therapeutic software component 120. Such reporting may help the developer 215 to understand how to calibrate a plurality of components to optimize the effect the therapeutic system 100 has on the therapeutic objective 110. For example, it may be learned that, everything else being equal, a therapeutic system using a particular device component 124 achieves a better result for a certain therapeutic objective 110. For another example, it may be learned that two (2) electronic therapeutic systems 100, both sharing the same therapeutic objective 110, the same software application component 121, and hosted on the same device 124, provide markedly different therapeutic effectiveness due to the fact that one incorporates an operating system 123 that is difficult to use, thereby discouraging engagement between the user 130 and the application 121, and the other system 100 that incorporates an operating system 123 that is convenient to use.

FIG. 5 is an exemplary Change Impact output report 410 presenting a sample of the output information generated by a system 100 that may be made available to a developer 215 of a therapeutic system 100 component as a constituent of the computing system 210. In the present example, developer 215 is provided with information indicating a measure of the therapeutic effectiveness of the therapeutic software component 120 of an electronic therapeutic system 100 over time relative to the therapeutic objective 110 of blood glucose control, represented in this example by A1c measurements. In the illustrated example, the developer 215 is presented with a Change Impact output report 410 corresponding to the measurement of A1c at various points in time. These points in time are represented in the example as “Events” and shown together with an “Event Date.” For each Event Date certain therapeutic target information, A1c measurements in this example, is provided to assist the developer to understand whether an Event has possibly affected the therapeutic target in an unexpected manner. Any number of Events may be presented, and corresponding therapeutic target measurements may be displayed in any manner appropriate to advance the developer's understanding of the therapeutic system 100 or any of its components.

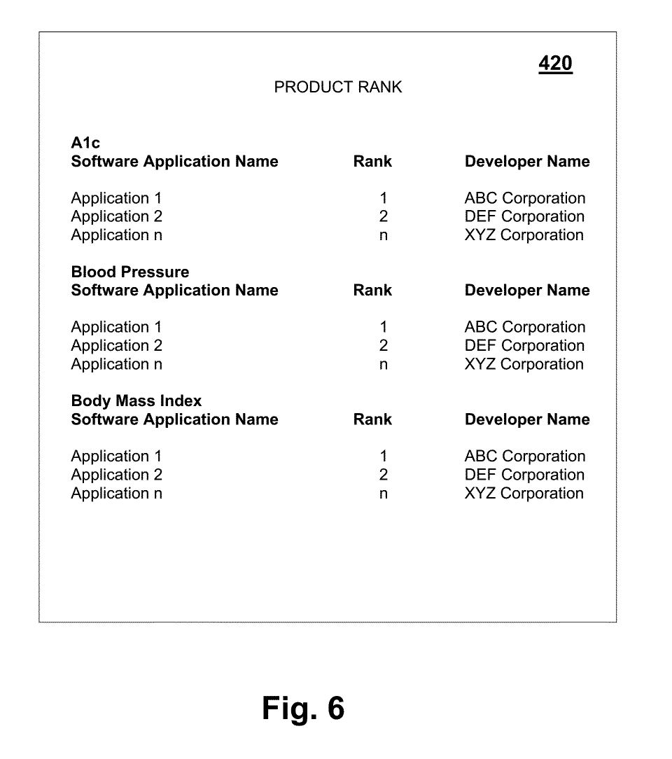

FIG. 6 is an exemplary Product Rank output report 420 presenting a sample of the output information generated by computing system 210 that may be made available to interested developers 215, third-party services 216 and healthcare constituents 217. In the example illustrated in FIG. 6, a physician, as a healthcare constituent 217, is provided with information about a plurality of application components 121. The output report 420 is organized according to the therapeutic objective. In the example, the following therapeutic objectives are shown: A1c, blood pressure, and Body Mass Index. Listed under each therapeutic objective are the Software Application name, the Developer name and the rank of the application (1 through n where n is greater than or equal to 1). The rank is assigned according to the relative effectiveness of the software application in terms of the targeted therapeutic objective as of the date of the output report 420. Access to such information by a physician may enable the physician to make better recommendations to a patient regarding which application 121 should be used to reach that patient's particular therapeutic objective. Access to such information by a consumer as a healthcare constituent 217, may also enable a consumer to make better choices about the application 121, operating system 123, or device 124 to use. It should be appreciated that such information would provide the content for a compendium of therapeutic software similar in practice to a compendium of drugs used today by physicians to assist them in considering alternative drug therapies for patients.

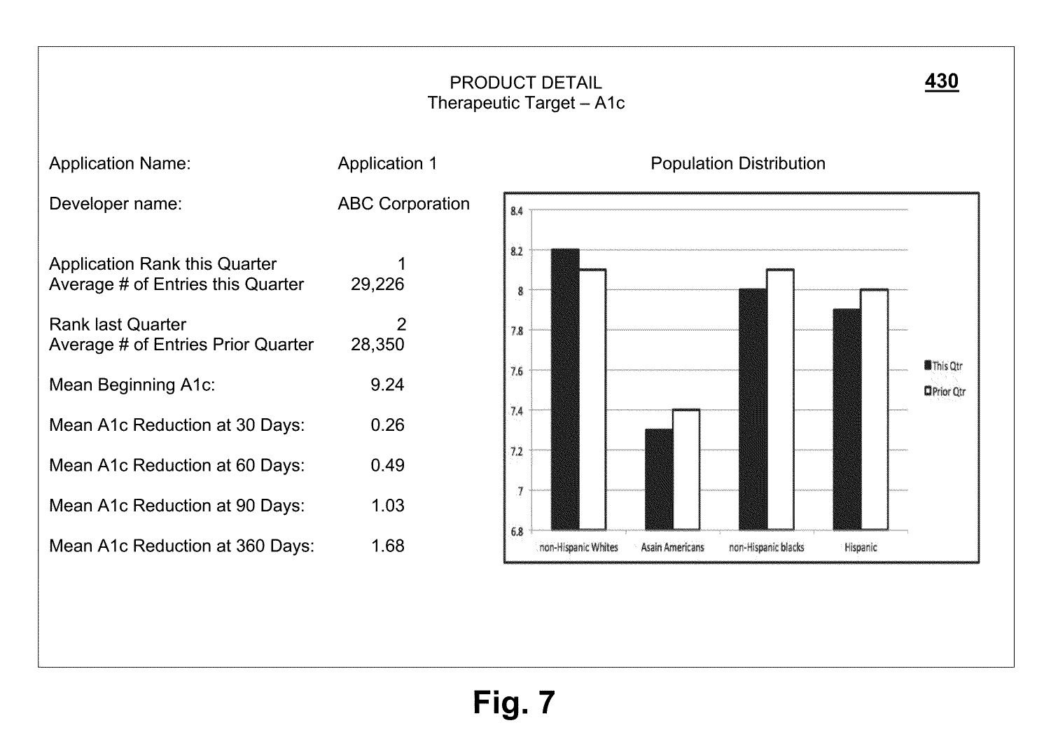

FIG. 7 is an exemplary Product Detail output report 430 presenting a sample of the output information generated by the system 100 about the application component 121 of an electronic therapeutic system 100 that may be made available to interested developers 215, third-party services 216 and healthcare constituents 217. The example output report 430 includes some information presented in FIGS. 4 and 6, but adds a comparison of Average Rank this Quarter to Average Rank Last Quarter. This may, for example, allow a physician or other healthcare constituent 217 to evaluate the quality of an application component 121 over time and consider comparisons with possible alternative application components 121. FIG. 7 also includes exemplary information depicting population information. If an application component collects population characteristics, then population distribution information may also be reported in association with a particular therapeutic system 100 or component. In the present example, a bar chart depicts the effectiveness of the Application 1 for two (2) calendar quarters, relative to four (4) distinct population groups. Such information may be useful, for example, to help match a particular patient to a particular therapeutic system, or prioritize improvements to a therapeutic system.

It should be appreciated that a wide range of output reports is possible and could address the comparative effectiveness of a device component 124 or any other component of therapeutic systems 100.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A computing system comprising:
a processor; and
a memory including programming that, when executed by the processor, causes the computing system to:
periodically receive data generated by a plurality of electronic therapeutic systems, wherein the data include the status of at least one therapeutic attribute, and wherein each of the plurality of electronic therapeutic systems includes a therapeutic objective;
monitor changes in the at least one therapeutic attribute over time; and
compare the effectiveness of two or more electronic therapeutic systems sharing the same therapeutic objective at creating a desired change in the at least one therapeutic attribute over time.

2. The computing system of claim 1, wherein each electronic therapeutic system includes a device component, an operating system component hosted on the device component, and a software application component accessible by the device component, and wherein the device component is communicatively coupled to the computing system.

3. The computing system of claim 2, wherein the device component is a general purpose computer, smart phone, tablet computer, wearable biometric tracking device or wearable computing device.

4. The computing system of claim 2, wherein the data generated by the plurality of electronic therapeutic systems include identification of the device component, the operating system component and the software application component.

5. The computing system of claim 4, wherein the memory includes programming that, when executed by the processor, causes the computing system to identify correlations between changes in the at least one therapeutic attribute and changes in at least one of the device component, the operating system component and the software application component.

6. The computing system of claim 1, wherein the data generated by the plurality of electronic therapeutic systems include personal characteristics of users of the plurality of electronic therapeutic systems.

7. The computing system of claim 6, wherein the memory includes programming that, when executed by the processor, causes the computing system to identify correlations between changes in the at least one therapeutic attribute and differences between the personal characteristics of the individuals.

8. The computing system of claim 1, wherein changes in the at least one therapeutic attribute that exceed a predetermined threshold are reported to a healthcare constituent, developer, or third-party service.

9. The computing system of claim 1, further comprising at least one data repository for storing the received data.

10. A computer-implemented method comprising:
receiving data generated by a plurality of electronic therapeutic systems, wherein the data include the status of at least one therapeutic attribute;
monitoring changes in the at least one therapeutic attribute over time; and
comparing the effectiveness of two or more electronic therapeutic systems at creating a desired change in the at least one therapeutic attribute over time,
wherein the data is received by a computing system communicatively coupled to the plurality of electronic therapeutic systems.

11. The computing-implemented method of claim 10, wherein each electronic therapeutic system includes a device component, an operating system component hosted on the device component, and a software application component accessible by the device component.

12. The computing-implemented method of claim 11, wherein the device component is a general purpose computer, smart phone, tablet computer, wearable biometric tracking device or wearable computing device.

13. The computing-implemented method of claim 11, wherein the data generated by the plurality of electronic therapeutic systems include identification of the device component, the operating system component and the software application component.

14. The computing-implemented method of claim 13, further comprising identifying correlations between changes in the at least one therapeutic attribute and changes in at least one of the device component, the operating system component and the software application component.

15. The computing-implemented method of claim 10, wherein the data generated by the plurality of electronic therapeutic systems include personal characteristics of users of the plurality of electronic therapeutic systems.

16. The computing-implemented method of claim 15, further comprising identifying correlations between changes in the at least one therapeutic attribute and differences between personal characteristics of users of the plurality of electronic therapeutic systems.

17. The computing-implemented method of claim 10, wherein reporting changes in the at least one therapeutic attribute that exceed the predetermined threshold comprises generating an output report to a healthcare constituent, developer, or third-party service reflecting changes in the at least one therapeutic attribute that exceed the predetermined threshold.

18. The computer-implemented method of claim 10, wherein the receiving data generated by a plurality of electronic therapeutic systems is received periodically.

19. The computer-implemented method of claim 10, wherein the receiving data generated by a plurality of electronic therapeutic systems is received continuously.

20. A non-transitory computer-readable medium comprising stored contents that configure a computing system to:
periodically receive data generated by a plurality of electronic therapeutic systems, each electronic therapeutic system including a therapeutic objective, a device component, an operating system component hosted on the device component, and a software application component accessible by the device component, and wherein the data include the status of at least one therapeutic attribute, personal characteristics of users of the plurality of electronic therapeutic systems, and identification of the device component, the operating system component and the software application component;
monitor changes in the at least one therapeutic attribute over time;
identify correlations between changes in the at least one therapeutic attribute and differences in the device component, operating system component, software application component, or personal characteristics of users of the plurality of electronic therapeutic systems; and
compare the effectiveness of two or more electronic therapeutic systems sharing the same therapeutic objective at creating a desired change in the at least one therapeutic attribute over time.
